(19) United States
(12) Patent Application Publication
(10) Pub. No.: US 2006/0174733 A1
(43) Pub. Date: Aug. 10, 2006

(54) Bendable and retainable spanner

(76) Inventor: Chih-Ching Hsieh, Taichung Hsien (TW)

Correspondence Address: Chih-Ching Hsieh, 235 Chung-Ho, Box 8-24, Taipei, TW

(21) Appl. No.: 11/054,136

(22) Filed: Feb. 10, 2005

(51) Int. Cl. B25B 23/16; B25G 1/00

(52) U.S. Cl. 81/177.8; 81/177.7

(57) ABSTRACT

A bendable and retainable spanner comprises a driving head having a driving portion capable of driving a screw; one end of the driving head having a pivotal block; a holding portion having a pivotal structure at one end thereof; a pivotal unit; two ends of the pivotal unit having pivotal grooves for receiving and retaining the pivotal block of the driving portion and the pivotal device of the holding portion by using pivotal shafts so as to pivotally install the pivotal block and the pivotal device; a center portion of the pivotal unit being formed with a receiving groove for receiving an adjusting wheel; an upper end a lower end of the adjusting wheel having respective screw holes; each screw hole being received with a respective buckle.

### FIELD OF THE INVENTION

The present invention relates to spanners, and in particular to a bendable and retainable spanner, wherein the spanner has a pivotal unit so that the driving head and holding portion at the two ends of the pivotal unit are bendable and retainable to a desired orientation so as to suit the work environment.

### BACKGROUND OF THE INVENTION

Generally, spanners are worked in various environments. However many working environments are not suitable to the spanners. Thereby there are some improvements being developed for improving the prior art difficulty.

In one improvement, the driving head and the holding portion are designed to have an angle therebetween so that the driving head is inclined to the holding portion. However the angle is fixed in the manufacturing process so that they are only suitable for some predetermined environments, but many working environments are not suited for this design.

In another improved design, the driving head is pivotally installed to the holding portion by the pivotal structures in the driving diving head and the holding portion. In this design, only one pivotal portion is designed, the driving head is parallel to the holding portion. Thereby the driving head and the holding portion has only one portion to be adjusted. The adjustable configuration is confined. Furthermore, the arm of force of the spanner when driving a screw is smaller and thus the operation is inconvenient, In one design, the holding portion of the spanner has a plurality of pivotal portions. However this design causes the holding portion to have some sections to be adjusted to different orientations to suit the environment, but this makes the use inconvenient in operation.

Furthermore, in one development design, one end of the driving head and the holding portion have respective connecting blocks. The connecting blocks have toothed surface. A connecting portion having teeth is installed between the driving head and the holding portion. The connecting portion has toothed surfaces resisting against the toothed surfaces of the connecting surfaces. Thereby the orientation is adjustable. However using the elements in the connecting blocks are complicated. Not only is the assembly work complicated, but also the manufacturing cost is high. Thereby the angle between the driving head and the holding portion is smaller so that there are only finite configurations that can be formed so that it cannot be used in various environments.

### SUMMARY OF THE INVENTION

Accordingly, the primary object of the present invention is to provide a bendable and retainable spanner, wherein the spanner has a pivotal unit so that the driving head and holding portion at the two ends of the pivotal unit are bendable and retainable to a desired orientation so as to suit the work environment.

To achieve the above objects, the present invention provides a bendable and retainable spanner. The spanner comprises a driving diving head having a driving portion capable of driving a screw; one end of the driving head having a pivotal block; a holding portion having a pivotal structure at one end thereof; a pivotal unit; two ends of the pivotal unit having pivotal grooves for receiving and retaining the pivotal block of the driving portion and the pivotal structure of the holding portion by using pivotal shafts so as to pivotally install the pivotal block and the pivotal structure; a center portion of the pivotal unit being formed with a receiving groove for receiving an adjusting wheel; an upper end a lower end of the adjusting wheel having respective screw holes; each screw hole being received with a respective buckle, wherein when rotating the adjusting wheel, the buckles at the upper and lower ends of the adjusting wheel will protrude out to resist against the pivotal block and the pivotal structure of the pivotal unit and the holding portion so as to fix the position relation between the driving head and the holding portion.

The various objects and advantages of the present invention will be more readily understood from the following detailed description when read in conjunction with the appended drawing.

### BRIEF DESCRIPTION OF THE DRAWINGS

FIG. 1 is an exploded perspective view of the bondable and retainable spanner of the present invention.

FIG. 2 is a perspective view of the bendable and retainable spanner of the present invention.

FIG. 3 is a structural cross sectional view about the bendable and retainable spanner of the present invention.

FIGS. 4 to 6 are cross sectional views showing the operation of the present invention.

FIG. 7 is an exploded perspective view showing the second embodiment of the present invention.

### DETAILED DESCRIPTION OF THE INVENTION

In order that those skilled in the art can further understand the present invention, a description will be described in the following in details. However, these descriptions and the appended drawings are only used to allow those skilled in the art to understand the objects, features, and characteristics of the present invention, but not to be used to confine the scope and spirit of the present invention defined in the appended claims.

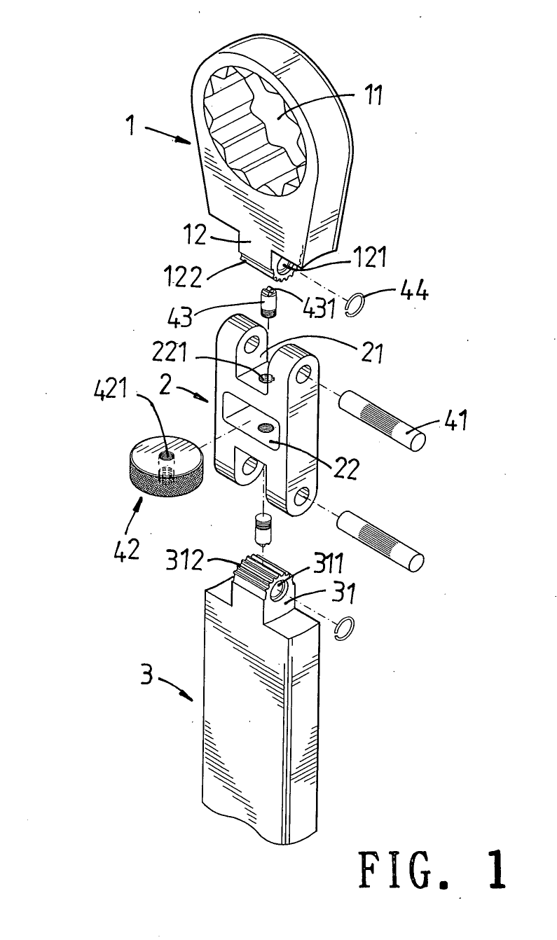

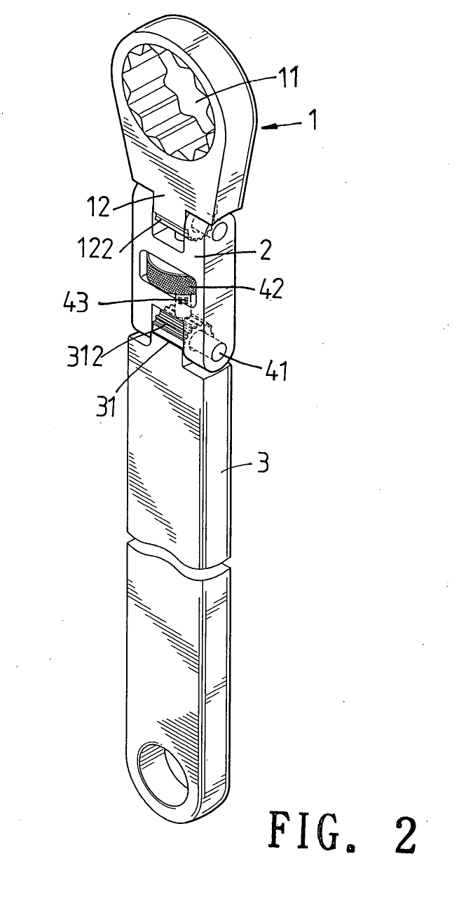

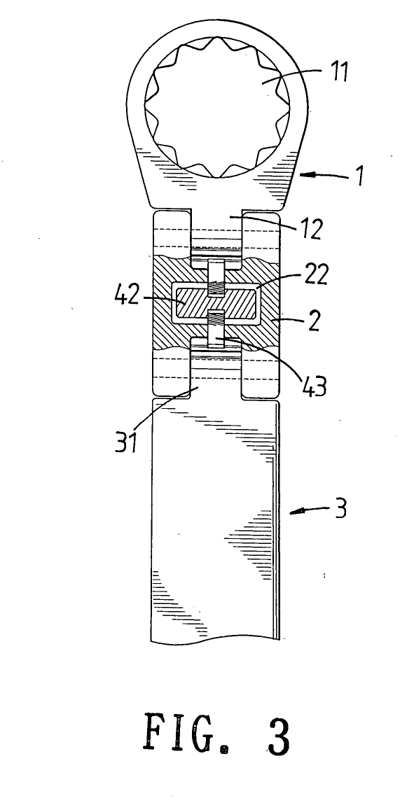

Referring to FIGS. 1 to 3, the bendable and retainable spanner of the present invention is illustrated. The present invention has the following elements. The bendable and retainable spanner has the following elements.

A driving head 1 has a driving portion 11 at a front end thereof. The driving portion 11 is engageable with a screw so as to drive the screw. A rear end of the driving head 1 is installed with a pivotal block 12 which is pivotally installed to a pivotal unit 2. An outer side of the pivotal block 12 is formed with a recess 121. A periphery of the pivotal block 12 is arranged with teeth 122.

The pivotal unit 2 has an integral formed H shape having two longitudinal shafts and a transversal bar between the two longitudinal shafts. An upper end of the pivotal unit 2 has an upper pivotal groove 21 between the upper ends of two longitudinal shafts and the transversal bar for receiving and retaining the pivotal block 12 of the driving portion 11 by using a pivotal shaft 41 to passing through an upper ends of the two longitudinal shafts and the pivotal block 12. A lower pivotal groove 21 is between lower ends of the two longitudinal shafts and the transversal bar for receiving and retaining the pivotal structure 31 of the holding portion 3 by using pivotal shafts 41 to pass through the lower ends of the two longitudinal shafts and the pivotal structure 31 so as to pivotally install the pivotal block and the pivotal structure 31. A center of the pivotal unit 2 is formed with a receiving groove 22. An upper end and a lower end of the receiving groove 22 are connected with the two pivotal grooves 21 through the penetrating holes 221. An adjusting wheel 42 is received within the receiving groove 22. A center of the adjusting wheel 42 has a screw hole 421. An upper end and a lower end of the screw hole 421 are received with respective buckles 43. A portion of each buckle 43 is received in the respective penetrating hole 221. The buckles 43 serve to confine the adjusting wheel 42 within the receiving groove 22. One end of the buckle 43 received in the penetrating hole 221 has a buckle portion 431.

A front end of the holding portion 3 is installed with a pivotal structure 31. The pivotal structure 31 is pivotally installed to the pivotal groove 21 of the pivotal unit 2. An outer side of the pivotal structure 31 is installed with a slot 311. A periphery of the pivotal structure 31 is formed with teeth 312. Other portion of the holding portion 3 other than the pivotal structure 31 serves to be held by users.

In assembly of the present invention, the adjusting wheel 42 is firstly installed within the receiving groove 22. Then two buckles 43 are received into the penetrating holes 211 from the pivotal grooves 21 and then are locked in the screw hole 421 of the adjusting wheel 42. Thereby the adjusting wheel 42 is confined in the receiving groove 22. The pivotal unit 2 of the driving head 1 and the pivotal structure 31 of the holding portion 3 are engaged to the pivotal grooves 21 of the pivotal unit 2. Then two pivotal shafts 41 are used to fix the driving diving head 1 and the holding portion 3 to the pivotal unit 2. Each of the pivotal shafts 41 is enclosed by a C ring 44 which is also received in the recess 121 of the pivotal block 12 and the slot 311 of the pivotal structure 31 so as to fix the pivotal shafts 41. Furthermore, the buckle portions 431 of the buckles 43 will resist against the teeth 122, 312 of the pivotal block 12 and pivotal structure 31 when the buckle portions 431 are protruded out of the penetrating holes 221. When the buckle portions 431 resist against the teeth 122, 312 of the pivotal block 12 and the pivotal structure 31, the driving head 1 and the holding portion 3 are fixed so that the orientation can not be adjusted. Therefore the assembly work is easy and quick.

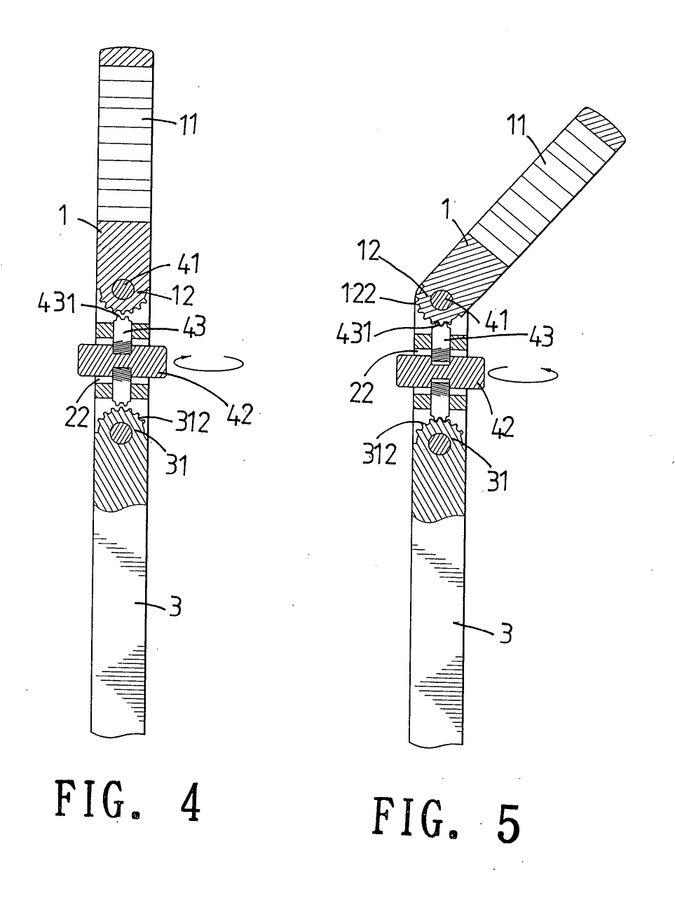

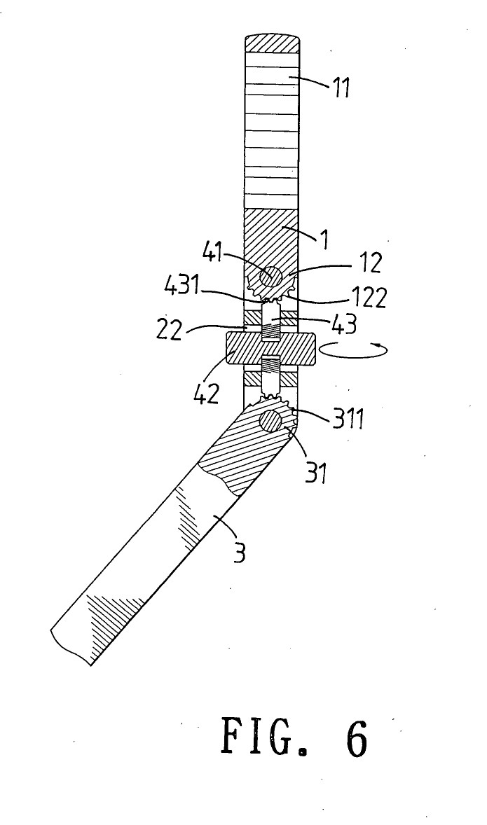

Referring to FIG. 4 to 6, in use of the present invention, by the design of the pivotal unit 2, the bendable and retainable spanner is adjusted by the working environment. The driving head 1 and the holding portion 3 at two ends of the pivotal unit 2 is adjusted to have a desired shape. By adjust the adjusting wheel 42, the buckles 43 could protrude out so that the buckle portions 431 will resist against the teeth 122, 412 of the pivotal block 12 and the pivotal structure 31 of the driving portion 11 and the holding portion 3 so as to fix the driving head 1 and the holding portion 3. Thereby the configuration is retained without deformation due to a force applied to the spanner. Thereby the present invention is suitable in various environment.

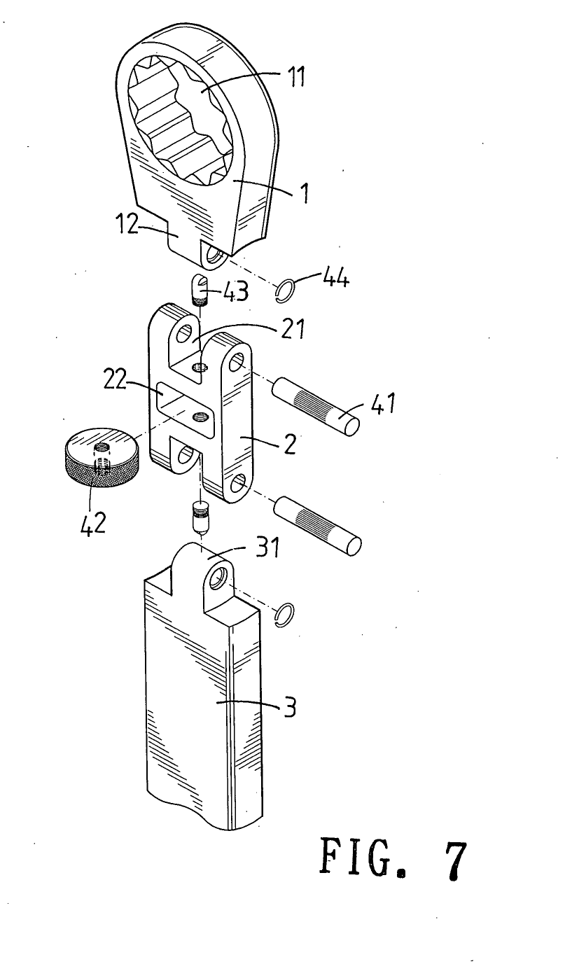

Referring to FIG. 7, the second embodiment of the present invention is illustrated. Those identical to the first embodiment will not be described here. Other the differences of the two are described here. To make the present invention being manufactured easily, the buckle portions 431 of the buckles 43 and the teeth 122, 312 of the pivotal block 12 and the pivotal structure 31 can be removed. In this case, the driving head 1 and holding portion 3 are fixed by the friction forces therebetween. Not only fewer elements are necessary, moreover the adjustment can be performed freely.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A bendable and retainable spanner comprising:
a driving head having a driving portion capable of driving a screw; one end of the driving head having a pivotal block;
a holding portion installed as a lower side of the driving head, the holding portion having a pivotal structure at one end thereof;
a pivotal unit; the pivotal unit having an integral formed H shape having two longitudinal shafts and a transversal bar between the two longitudinal shafts; an upper end of the pivotal unit having an upper pivotal groove between the upper ends of two longitudinal shafts and the transversal bar for receiving and retaining the pivotal block of the driving portion by using a pivotal shaft to passing through an upper ends of the two longitudinal shafts and the pivotal block; and a lower pivotal groove between lower ends of the two longitudinal shafts and the transversal bar for receiving and retaining the pivotal structure of the holding portion by using pivotal shafts to pass through the lower ends of the two longitudinal shafts and the pivotal structure so as to pivotally install the pivotal block and the pivotal structure; a center portion of thy transversal bar of the pivotal unit being formed with a receiving groove for receiving an adjusting wheel; an upper end and a lower end of the adjusting wheel having respective screw holes; each screw hole being received with a respective buckle, wherein when rotating the adjusting wheel, the buckles at the upper and lower ends of the adjusting wheel will protrude out to resist against the pivotal block of the driving head and the pivotal structure of the holding portion so as to fix the position relation between the driving head and the holding portion.

2. The bendable and retainable spanner as claimed in claim 1, wherein a lower periphery of the pivotal block is formed with teeth; one end of each buckle is formed with a buckle portion; as the buckle portions resist against the teeth of the pivotal block, the driving head is firmly secured with respect to the holding portion.

3. The bendable and retainable spanner as claimed in claim 1, wherein each pivotal shaft is fixed by a C ring enclosed around the pivotal shaft.
